(19) United States
(12) Patent Application Publication
(10) Pub. No.: US 2026/0346994 A1
(43) Pub. Date: Nov. 5, 2026

(54) METHOD FOR MANUFACTURING AN AERODYNAMIC PANEL FOR AN AIRCRAFT PROPULSION ASSEMBLY

(71) Applicant: SAFRAN NACELLES, Gonfreville-L'Orcher (FR)

(72) Inventor: Florian PEU, Moissy-Cramayel (FR)

(21) Appl. No.: 19/486,332

(22) PCT Filed: May 23, 2024
(86) PCT No.: PCT/FR2024/050664

§ 371 Date: Nov. 20, 2025

(30) Foreign Application Priority Data
May 26, 2023 (FR) FR2305231

(51) Int. Cl. B64D 29/00; B23K 20/12; B23K 101/00; B64F 5/10

(52) U.S. Cl. CPC B64D 29/00; B23K 20/127; B23K 20/129; B64F 5/10; B23K 2101/006

(57) ABSTRACT

A method for manufacturing an aerodynamic panel for an aircraft propulsion assembly, including the following steps: a) applying at least one reinforcement plate to a first face of a wall; b) rigidly attaching the reinforcement plate to the wall by friction stir welding; c) producing through-holes through the wall and the reinforcement plate, these holes being formed through the weld seam; and d) fitting screws into the holes, these screws including countersunk heads that have a thickness greater than the thickness of the wall and less than the thickness of the weld seam.

### TECHNICAL FIELD OF THE INVENTION

This invention relates to a method of manufacturing an aerodynamic panel for an aircraft propulsion assembly, and to an aerodynamic panel obtained by this method.

### TECHNICAL BACKGROUND

Technical Background Comprises the Documents U.S. Pat. No. 9,845,728 B2, US-A1-2015/291273 and U.S. Pat. No. 6,213,379 B1.

A propulsion assembly comprises a turbomachine surrounded by a nacelle. The propulsion assembly comprises aerodynamic panels which are panels configured to be swept by one or more gas flow flowing along the propulsion assembly during operation. These panels may be cowls of the nacelle configured to be swept by a gas flow external to the propulsion assembly, or the casings of the turbomachine configured to be swept by a secondary flow, for example.

An aerodynamic panel comprises an aerodynamic face capable of being swept by the gas flow. This panel is fixed to the nacelle or the turbomachine by screws that pass through the panel. Elements can also be fixed to a panel of this type by screws.

The panel has preferably the thinnest possible thickness to limit its mass. However, this thickness must not be too thin at the screws to withstand the stresses in the fastening areas of the panel or elements.

To overcome this problem, it is known to use a thick panel and to machine it in such a way as to leave extra thicknesses only in the fastening areas comprising passage holes for the fastening screws.

Another solution would be to attach a reinforcing plate to the wall. The reinforcing plate would be fitted to the face of the panel opposite its aerodynamic face, and this reinforcing plate would include holes aligned with the holes in the wall, for the fastening screws to pass through.

The screws are countersunk head screws, i.e. screws whose heads have a generally frustoconical shape and are configured to be engaged in the flared parts of the holes located on the side of the aerodynamic face of the wall. The larger the diameter of the screws, the greater the axial dimension or thickness of their countersunk heads. With current technology, it is not possible to use screws whose countersunk heads have a thickness or axial dimension greater than ⅔ of the thickness of the panel, as the resulting assembly would not be optimal in that the panel would not be properly tightened by the screws on the reinforcing plate.

The present invention proposes a simple, effective and economical solution to this problem.

### SUMMARY OF THE INVENTION

The present invention relates to a method for manufacturing an aerodynamic panel for an aircraft propulsion assembly, the method comprising the following steps:
a) applying at least one reinforcing plate to a first face of a wall, the reinforcing plate covering a part of this first face and the wall comprising a second face, opposite the first face, which is a face capable of being swept by a gas flow when the panel is mounted in a propulsion assembly,
b) securing the reinforcing plate to the wall by friction stir welding using a tool comprising a welding head which is moved over the second face so as to create a weld bead which extends in thickness from the second face over an entire thickness of the wall and over at least a part of a thickness of the reinforcing plate,
c) producing through-holes through the wall and the reinforcing plate, these holes being formed through the weld bead, and
d) fitting screws into the holes, these screws comprising countersunk heads which are located on the side of said second face and aligned with this face, these countersunk heads having a thickness or axial dimension less than said thickness of the weld bead.

In the present application, the (axial) thickness or axial dimension of the countersunk heads is measured along the axes of elongation of the screws. As the screws pass through the wall and the reinforcing plate, they extend through the thicknesses of these elements. It is therefore understood that the thicknesses of the wall, the reinforcing plate, the weld bead and the screws are measured in directions parallel to and generally perpendicular to the faces of the wall.

A first advantage of the invention is that the thickness of the countersunk heads, and therefore the diameter of the screws, is not limited by the thickness of the wall. This means that thinner walls than in the previous technique can be used in the present invention, which is also advantageous in terms of mass and cost. The thickness of the weld bead is determined, on the one hand, by the thickness of the wall and, on the other hand, by the thickness or axial dimension of the countersunk heads of the screws. The thickness of the weld bead is greater than the thickness of the wall so that the weld bead extends into the reinforcing plate and secures it to the wall. The thickness of the weld bead is also greater than the thickness or axial dimension of the countersunk heads of the screws, so that they are fully housed in the thickness of the weld bead. Finally, the thickness or axial dimension of the countersunk heads of the screws is greater than the thickness of the wall, to ensure optimum support for the wall and the reinforcing plate.

Advantageously, the countersunk heads have a thickness or axial dimension greater than ⅔ of the thickness of the weld bead.

According to the invention, the welding is carried out by friction stir welding (FSW). This type of welding is advantageous because it requires no filler material. In addition, this type of welding does not generate a protruding weld bead. Instead, the weld bead produced is relatively flat and generally has a free external surface that is aligned with the face of the wall over which the head of the welding tool moves. However, the face of the wall can be sanded and/or finished to perfect its surface finish.

The double attachment of the wall and the reinforcing plate, by means of the weld bead and screws, improves the transmission of forces and therefore the life of the panel.

The method according to the invention may comprise one or more of the following characteristics, taken alone or in combination with each other:
the weld bead is produced in a single pass in step b);
the method comprises, after step d), a step e) of fastening an element to the reinforcing plate, on the side opposite said wall, this element comprising holes through which said screws pass, which receive nuts which are screwed onto the screws and which bear on the element;
the element is a mounting or a fishplate;
the method comprises, between steps b) and c), a step i) of sanding a free external surface of the weld bead;
the panel has a thickness, preferably constant, of between 1 and 3 mm, and preferably between 1.5 and 2 mm;
the weld bead has a width of between 5 and 15 mm;
the weld bead has a thickness of between 1.5 and 4 mm, and preferably between 1.5 and 3 mm;
the countersunk heads have a thickness or axial dimension greater than ⅔ (two thirds) of said thickness of the weld bead;
the wall and the reinforcing plate are made of metallic materials, and are for example made of the same metal alloy;
the reinforcing plate has a thickness greater than that of the wall; alternatively, its thickness could be the same or less;
the reinforcing plate has a thickness, preferably constant, of between 2 and 4 mm.

The present invention also relates to an aerodynamic panel for an aircraft propulsion assembly, this panel being obtained by the method described above and comprising:
a wall comprising a first face and a second face opposite the first face, this second face being capable of being swept by a gas flow when the panel is mounted in a propulsion assembly,
a reinforcing plate which covers part of this first face and which is secured to the wall by a weld bead, this weld bead comprising a free external surface which is aligned with said second face, this weld bead comprising holes passing through the wall and the reinforcing plate, and
screws mounted in the holes and comprising countersunk heads which are located on the side of said second face and aligned with this face and the free external surface of the weld bead, these countersunk heads having a thickness or axial dimension greater than a thickness of the wall and less than a thickness of the weld bead.

The panel according to the invention may comprise one or more of the following characteristics, taken in isolation from each other or in combination with each other:
the panel has a thickness, preferably constant, of between 1 and 3 mm, and preferably between 1.5 and 2 mm;
the weld bead has a width of between 5 and 15 mm;
the weld bead has a thickness of between 1.5 and 4 mm, and preferably between 1.5 and 3 mm;
the countersunk heads have a thickness or axial dimension greater than ⅔ (two thirds) of said thickness of the weld bead;
the wall and the reinforcing plate are made of metallic materials and are, for example, made of the same metal alloy;
the reinforcing plate has a thickness greater than that of the wall; alternatively, its thickness could be the same or less;
the reinforcing plate has a thickness, preferably constant, of between 2 and 4 mm.

The present invention also relates to an aircraft propulsion assembly, comprising an aerodynamic panel as described above.

### BRIEF DESCRIPTION OF THE FIGURES

Other characteristics and advantages of the invention will become apparent from the detailed description which follows, for the understanding of which reference is made to the annexed drawings in which:

FIG. 1 is a schematic half-view of an aircraft propulsion assembly in axial section,

FIG. 2 is a schematic perspective view of an embodiment of an aerodynamic panel according to the invention,

FIG. 3 is a block diagram illustrating an embodiment of a manufacturing method according to the invention,

FIG. 4 is a sectional view of the panel shown in FIG. 2,

FIG. 5 is a larger scale view of a part of FIG. 3,

FIG. 6 is a similar view to that of FIG. 4 and shows dimensions.

FIG. 7a is a schematic view of a countersunk head of a first embodiment of a fastening screw, and

FIG. 7b is a schematic view of a countersunk head of a second embodiment of a fastening screw.

### DETAILED DESCRIPTION OF THE INVENTION

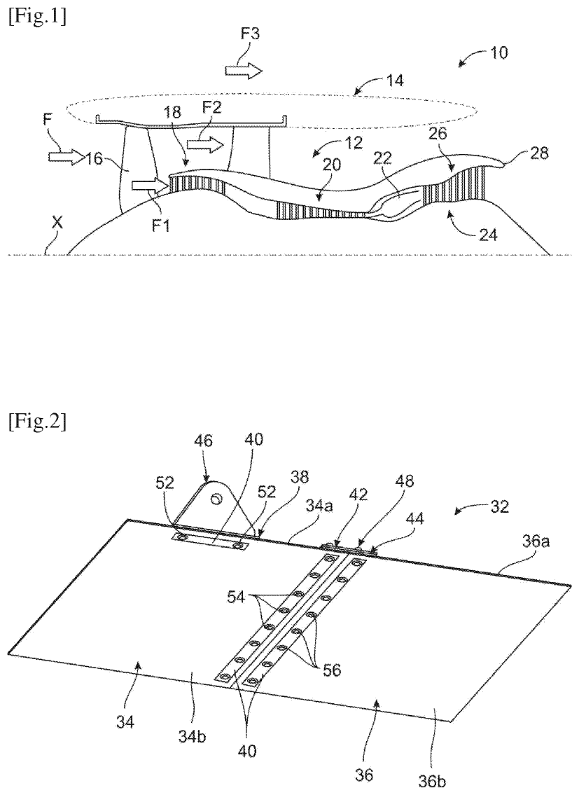

FIG. 1 shows a propulsion assembly 10 for an aircraft, this propulsion assembly 10 comprising a turbomachine 12 surrounded by a nacelle 14. The turbomachine 12 is of the dual-flow type. However, this is not limitative and the turbomachine 12 may be of another type, such as a turboprop engine.

The turbomachine 12 extends along a longitudinal axis X and comprises from upstream to downstream, in the direction of gas flow, a fan 16, one or more compressor stages (for example a low-pressure compressor 18 and a high-pressure compressor 20), an annular combustion chamber 22, one or more turbine stages (for example a high-pressure turbine 24 and a low-pressure turbine 26), and a gas exhaust nozzle 28.

The fan 16, the low-pressure compressor 18 and low-pressure turbine 26 are connected to a low-pressure shaft extending along the longitudinal axis X. The high-pressure compressor 20 and the high-pressure turbine 24 are connected to a high-pressure shaft formed around the low-pressure shaft. The low-pressure turbine 26 drives the low-pressure shaft in rotation, while the high-pressure turbine 26 drives the high-pressure shaft in rotation.

The nacelle 14 is centered on the longitudinal axis X and defines an annular vein around the turbomachine 12.

The gas flow F which passes through the fan 16 inside the nacelle 14 is divided downstream of the fan 2 into two annular and coaxial flows. A first flow, called the primary flow F1, flows into the turbomachine and is compressed in the compressors 18 and 20, mixed with fuel and burnt in the combustion chamber 22, then expanded in the turbines 24 and 26, and finally discharged through the nozzle 28. A second flow, called the secondary flow F2, flows in the annular duct around the turbomachine 12 and can provide most of the thrust of the turbomachine, particularly when the latter is of the high bypass ratio type.

In addition, a gas flow F3 flows around the nacelle 14 during operation.

The propulsion assembly 10 comprises aerodynamic panels which are panels configured to operation to be swept by one or more gas flow flowing along the propulsion assembly 10. These panels may be cowlings of the nacelle 14 configured to be swept by the gas flow F3, casings of the turbomachine 12 designed to be swept by the secondary flow F2, and so on.

The present invention is an improvement on such a panel, as well as on its manufacturing method.

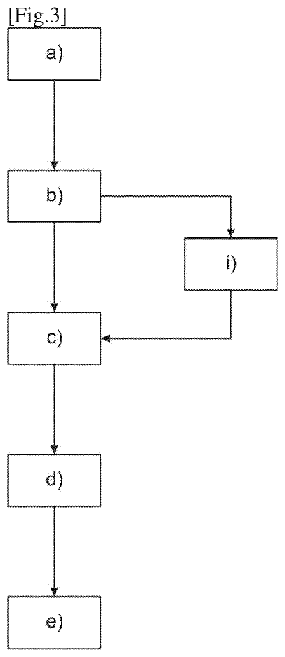

FIG. 2 illustrates an embodiment of a panel 32 according to the invention and FIG. 3 illustrates an example of a manufacturing method for this panel 32. The panel 32 comprises a wall 34 with a first face 34a and a second face 34b opposite the first face 34a. This second face 34b can be swept by a gas flow when the panel 32 is mounted in the propulsion assembly 10, as described above.

The panel 32 may comprise one or more other walls 36. It may, for example, comprise another adjacent wall 36, which is arranged alongside wall 34 and aligned with it. The two walls 34, 36, for example, are configured to be fastened or secured to each other.

As is the case with wall 34, the wall 36 comprises a first face 36a and a second face 36b opposite the first face 36a. This second face 36b can be swept by a gas flow when the panel 32 is mounted in the propulsion assembly 10, as described above. The faces 34b and 36b are configured to be aligned together.

The walls 34 and 36 may be identical.

Said or each wall 34, 36 has a generally parallelepiped shape in the example shown, although this aspect is not limiting.

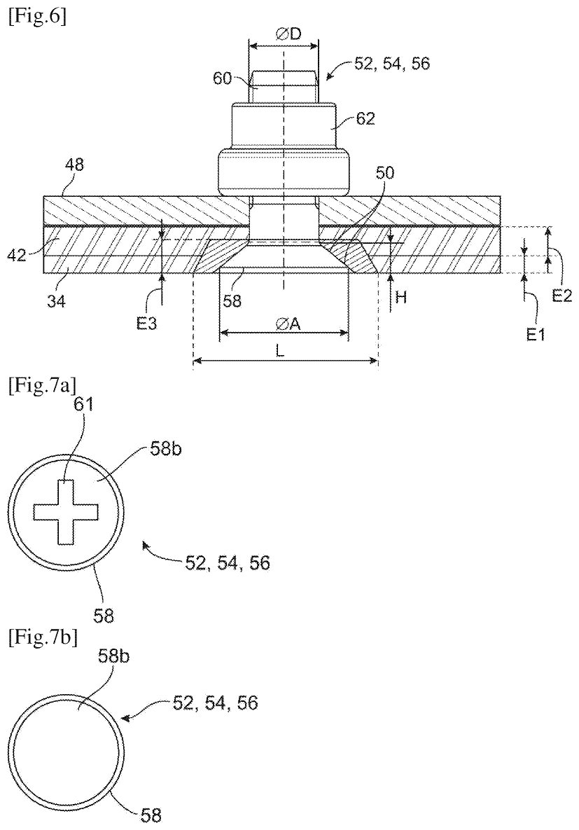

Said or each wall 34, 36 has a thickness, preferably constant, of between 1 and 3 mm, and preferably between 1.5 and 2 mm. This thickness is marked E1 in FIG. 6.

Said or each wall 34, 36 is made of metallic materials. They are preferably made from the same metal alloy, for example aluminium or titanium.

Said or each wall 34, 36 may be flat, as in the example shown, or curved.

The panel 32 also comprises at least one reinforcing plate 38 which covers part of the first face 34a of the wall 34 and which is secured to this wall 34 by a weld bead 40.

The reinforcing plate 38 therefore extends over only part of the face 34a, and is therefore located in an area that needs to be reinforced. The plate 38 therefore locally reinforces the wall 34.

The panel 32 may comprise one or more other reinforcing plates 42, 44. For example, it may comprise a further reinforcing plate 42 which is disposed on the face 34a of the wall 34, along an edge adjacent to the wall 36, and a further reinforcing plate 44 which is disposed on the face 36a of the wall 36, along an edge adjacent to the wall 34.

Each of the reinforcing plates 38, 42, 44 is secured to the wall 34, 36 by a weld bead 40.

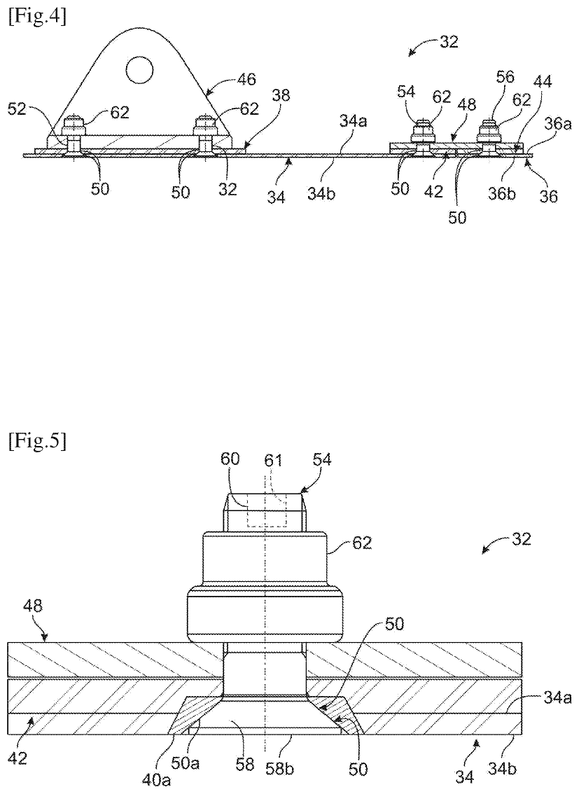

Each of the reinforcing plates 38, 42, 44 comprises a first face applied against the face 34a, 36a of the wall 34 or 36, and a second face 40b opposite the first face (see FIGS. 4 and 5).

This second face 40b is suitable for receiving an element to be fastened.

In the example shown, the second face 40b of the reinforcing plate 38 receives a mounting 46, and the second faces 40b of the reinforcing plates 42, 44 receive a fishplate 48 which is applied to these two faces 40b.

Said or each reinforcing plate 38, 42, 44 has a generally parallelepiped shape in the example shown, although this aspect is not limiting.

Said or each reinforcing plate 38, 42, 44 has a thickness, preferably constant, and advantageously greater than the thickness E1 of said or each wall 34, 36. Where each reinforcing plate 38, 42, 44 has a thickness preferably between 2 and 4 mm. This thickness is marked E2 in FIG. 6.

Said or each reinforcing plate 38, 42, 44 is made of metallic materials. They are preferably made from the same metal alloy as the walls 34 and 36, for example aluminium or titanium. Said or each reinforcing plate 38, 42, 44 can be flat, as in the example shown, or curved.

The panel 32 also comprises holes 50 for fitting screws 52, 54, 56 for fixing the above-mentioned elements, such as the mounting 46 and the fishplate 48.

The holes 50 are through-holes and are formed in said or each wall 34, 36 and in said or each reinforcing plate 38, 42, 44, as well as in the elements to be fastened.

In the example shown, the reinforcing plate 38 comprises two holes 50 which are aligned with two holes 50 in the wall 34 and two holes in the mounting 46. These holes 50 receive fastening screws 52. The reinforcing plate 42 comprises eight holes 50 which are aligned with eight holes in the wall 34 and eight holes in the fishplate 48. These holes 50 receive fastening screws 54. The reinforcing plate 44 comprises eight holes 50 which are aligned with eight holes in the wall 36 and a further eight holes in the fishplate 48. These holes 50 receive fastening screws 56.

Each of the screws 52, 54, 56 is of the countersunk head type and comprises a countersunk head 58 located at one end of a rod 60 which is at least partly threaded (see FIG. 5). The rod 60 passes through the holes 50 and the countersunk head 58 is housed in a flared section 50a of the hole 50 formed in the wall 34, 36. The countersunk head 58 is configured to be fully housed in this flared section 50a, as can be seen in the drawings, so that its end surface 58b is aligned with the face 34b, 36b of the wall 34, 36.

As can be seen in FIGS. 7a and 7b, this end surface 58b may comprise a recessed indentation 61 to enable engagement with a tool for tightening/loosening the screw 52, 54, 56, particularly when the latter is of the dismantling type. Alternatively, the screw 52, 54, 56 is of the non-removable type and does not comprise an indentation on its end surface 58b, which is then smooth.

The rod 60 of each screw 52, 54, 56 receives a nut 62 which is screwed and tightened against the element to be fastened. If the screw 52, 54, 56 is of the non-removable type, the end of the rod 60, opposite the countersunk head 58 may comprise an indentation 61 for engaging with a tool for immobilizing the screw during rotation when screwing and tightening the nut 62 (see FIG. 5). Said or each screw 52, 54, 56 has a diameter noted D in FIG. 6, this diameter being that of its rod 60. The diameter of the screw head 58 is noted A.

The countersunk head 58 of said or each screw 52, 54, 56 has an axial thickness or dimension (along the axis of elongation of the screw) which is noted H.

Preferably, H is greater than E1 and is between E1 and E1+E2.

The panel 32 also comprises weld beads 40 to secure the reinforcing plates 38, 42, 44 to the walls 34, 36, as described above.

In the example shown, a first weld bead 40 is formed between the wall 34 and the reinforcing plate 38. A second weld bead 40 is formed between the wall 34 and the reinforcing plate 42, along the aforementioned edge of the wall 34, and a third weld bead 40 is formed between the wall 36 and the reinforcing plate 44, along the aforementioned edge of the wall 36.

Each of the weld beads 40 has a generally elongated shape.

Each weld bead 40 can be produced in a single pass. Alternatively, the weld bead 40 could be produced in two or more passes.

The special character of each weld bead 40 is that it is formed by friction stir welding (or FSW). This welding technique is familiar to those skilled in the art of welding and will not be described in detail below.

The weld bead 40 has a free external surface 40a which is aligned with the second face 34b, 36b of the corresponding wall 34, 36. The weld bead 40 extends in thickness from this face 34b, 36b over the entire thickness E1 of the wall 34, 36 and over at least part of the thickness E2 of the reinforcing plate 38, 42, 44 (FIGS. 5 and 6).

The thickness of the weld bead 40 is shown as E3 in FIG. 6. For example, it is between 1.5 and 4 mm, and preferably between 1.5 and 3 mm.

The weld bead 40 has a width (measured in a direction transverse to the axis of elongation of the weld bead) that is greater than D and A. D and A can be between 4 and 12 mm. The width, denoted L in FIG. 6, of the weld bead 40 is preferably between 5 and 15 mm.

Preferably, H is less than or equal to E3 and more preferably strictly less than E3. Preferably, H is greater than ⅔ of E3.

Preferably, H is greater than or equal to E1+⅓×E1.

According to the invention, the holes 50 are formed in the weld bead 40, as shown in the drawings. The holes 50 are therefore formed in the panel 32 after the welding.

FIG. 3 illustrates a method for manufacturing a panel 32 according to one embodiment of the invention.

The method comprises several steps, some of which are optional.

The method comprises the following steps:
a) applying at least one reinforcing plate 38, 42, 44 to a first face 34a of a wall 34, the reinforcing plate 38, 42, 44 covering a part of this first face 34a and the wall 34 comprising a second face 34b, opposite the first face, which is a face capable of being swept by a gas flow when the panel 32 is mounted in a propulsion assembly,
b) securing the reinforcing plate 38, 42, 44 to the wall 34 by friction stir welding using a tool comprising a welding head which is moved over the second face 34b so as to create a weld bead 40 which extends in thickness from the second face 34b over an entire thickness E1 of the wall 34 and over at least a part of a thickness E2 of the reinforcing plate 38, 42, 44,
c) producing through-holes 50 through the wall 34 and the reinforcing plate 38, 42, 44, these holes 50 being formed through the weld bead 40, and
d) fitting screws 52, 54, 56 into the holes 50, these screws 52, 54, 56 comprising countersunk heads 58 which are located on the side of the second face 34b and aligned with this face 34b, these countersunk heads 58 having a thickness H or axial dimension greater than the thickness E1 of the wall 34 and less than the thickness E3 of the weld bead 40.

As mentioned above, the weld bead 40 can be produced in a single pass in step b).

After step d), the method may comprise a step e) of fastening an element to the reinforcing plate 38, 42, 44, on the side opposite the wall 34, this element comprising holes 50 through which screws 52, 54, 56 pass, which receive nuts 62 which are screwed onto the screws 50 and which bear on the element. The element is, for example, a mounting 46 or a fishplate 48.

Between steps b) and c), the method may comprise a step i) of sanding the free external surface 40a of the weld bead 40.

The present invention allows, in particular, the production of optimized panels that meet the exact requirements in terms of mass, cost, and integration of fasteners.

1. A method for manufacturing an aerodynamic panel for an aircraft propulsion assembly, the method comprising the following steps:
a) applying at least one reinforcing plate to a first face of a wall, the reinforcing plate covering a part of this first face and the wall comprising a second face, opposite the first face, which is a face capable of being swept by a flow of gas when the panel is mounted in a propulsion assembly,
b) securing the reinforcing plate to the wall by friction stir welding using a tool comprising a welding head which is moved over the second face so as to create a weld bead which extends in thickness from the second face over an entire thickness of the wall and over at least a part of a thickness of the reinforcing plate,
c) producing through-holes- through the wall and the reinforcing plate, these holes being formed through the weld bead, and
d) fitting screws into the holes, these screws comprising countersunk heads which are located on the side of said second face and aligned with this face these countersunk heads having a thickness or axial dimension greater than said thickness of the wall and less than said thickness of the weld bead.

2. The method according to claim 1, wherein the weld bead is produced in a single pass in step b).

3. The method according to claim 1, wherein said method comprises, after step d), a step e) of fastening an element to the reinforcing plate on the opposite side to said wall, this element comprising holes through which said screws pass, which receive nuts which are screwed onto the screws and which bear on the element.

4. The method according to claim 3, wherein the element is a mounting or a fishplate.

5. The method according to claim 1, wherein said method comprises, between steps b) and c), a step i) of sanding a free external surface of the weld bead.

6. The method according to claim 1, wherein the panel has a thickness, preferably constant, of between 1 and 3 mm, and preferably between 1.5 and 2 mm.

7. The method according to claim 1, wherein the weld bead has a width (L) of between 5 and 15 mm.

8. The method according to claim 1, wherein the weld bead has a thickness of between 1.5 and 4 mm, and preferably between 1.5 and 3 mm.

9. The method according to claim 1, wherein the countersunk heads have a thickness or axial dimension greater than ⅔ of said thickness of the weld bead.

10. The method according to claim 1, wherein the wall and the reinforcing plate are made of metallic materials, and are for example made of the same metal alloy.

11. An aerodynamic panel for an aircraft propulsion assembly, this panel being obtained by the method according to claim 1 and comprising:
a wall comprising a first face and a second face opposite the first face, this second face being capable of being swept by a gas flow when the panel is mounted in a propulsion assembly,
a reinforcing plate, which covers part of this first face and which is secured to the wall by a weld bead, this weld bead comprising a free external surface which is aligned with said second face, this weld bead comprising holes passing through the wall and the reinforcing plate, and
screws mounted in the holes and comprising countersunk heads which are located on the side of said second face and aligned with this face and the free external surface of the weld bead, these countersunk heads having a thickness or axial dimension greater than a thickness of the wall and less than a thickness of the weld bead.

12. An aircraft propulsion assembly comprising an aerodynamic panel according to claim 11.
